(19) United States
(12) Patent Application Publication
(10) Pub. No.: US 2002/0024674 A1
(43) Pub. Date: Feb. 28, 2002

(54) Device and process for measuring the parallelism and aligned position of rollers

(76) Inventors: Christian Albrecht, Munchen (DE); Michael Hermann, Villingen (DE)

Correspondence Address: NIXON PEABODY, LLP, 8180 GREENSBORO DRIVE, SUITE 800, MCLEAN, VA, 22102, US

(21) Appl. No.: 09/925,625

(22) Filed: Aug. 10, 2001

Related U.S. Application Data
(63) Continuation-in-part of application No. PCT/DE00/0437, filed on Dec. 8, 2000.

(30) Foreign Application Priority Data
Dec. 10, 1999 (DE) 199 59 866.5

(51) Int. Cl. G01B 11/14

(52) U.S. Cl. 356/614

(57) ABSTRACT

Quantitative determination of the parallelism and amount of alignment of rollers, or the like, is enabled by a measurement device and optionally the pertinent adapter which is attached to the end faces of these rollers. In a special embodiment of the invention there is a projection device for emitting a light beam or a light fan. The light beams emitted by it are incident on a receiving device which has high precision. The receiving device is likewise attached to the end face surface of a roller.

### CROSS-REFERENCE TO RELATED APPLICATION

This application is a continuation-in-part of co-pending International Patent Application No. PCT/DE00/04375 filed Dec. 8, 2000 and which designated the United States.

### BACKGROUND OF THE INVENTION

1. Field of the Invention

The invention relates to a device for measuring the parallelism of rollers or other bodies based on high-precision optical gyroscopes or gyroscopes which operate with high precision with micro-mechanically produced oscillators is known and methods for checking alignment therewith.

2. Description of Related Art

One example of the type of method and arrangement for checking the alignment of rollers or other bodies for parallelism is disclosed in U.S. Pat. No. 5,430,539. As disclosed therein, laser beam transmitters are detachably fastened to each roller by attachment devices.

### SUMMARY OF THE INVENTION

An object to be achieved is to measure the parallelism of rollers more easily.

Another object is to determine the aligned position (i.e., the offset in the axial direction) of cylindrical bodies, such as rollers, and the like, comfortably, easily and economically.

These and other objects are achieved by a device and its use, and a process for producing such a device, which make it possible for a measurement device for determining the angular orientation of a body to be attached directly to an end face or a cylinder cover surface. In another embodiment of the invention, these and other objects are achieved by a device, which acts as an adapter, in which a measurement device for determining the angular orientation of a body can be attached to an end face. In still another embodiment of the invention, these and other objects are achieved by a projection device for sending a light beam or a light fan, which cooperates with a receiving device, which allows an accurate impact site of such a light beam or light fan to be determined in a very precise manner.

### BRIEF DESCRIPTION OF THE DRAWINGS

Exemplary embodiments of this invention will be described in detail, with reference to the following figures, wherein:

FIG. 1 shows a perspective view of a first exemplary embodiment of the invention;

FIG. 2 shows a perspective view of a second exemplary embodiment of the invention which contains an intermediate piece which acts as an adapter;

FIG. 3 shows another exemplary embodiment of the invention, similar to FIG. 2, with a measurement device which has been made differently;

FIG. 4 shows a side view of the axle and adapter of FIGS. 2 and 3 in partial cross section;

FIG. 5 shows a side view of the axle and protective cap of FIG. 4;

FIG. 6 shows a perspective view of an exemplary operation of the measurement instruments for measuring or checking the aligned position of two rollers in accordance with the invention;

FIG. 7 shows an enlarged view of a light strip on a CMOS pixel sensor for displaying and indicating a possible alignment error between two rollers.

### DETAILED DESCRIPTION OF THE INVENTION

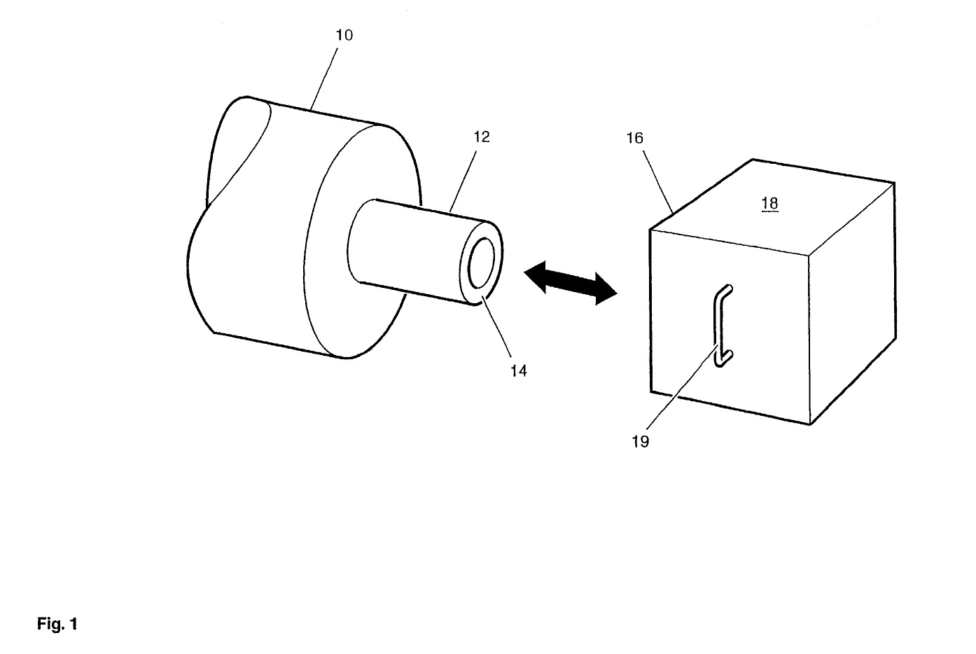

FIG. 1 shows a surface (end face) 14 of an axle 12 which has been machined with high precision. The surface of axle 12 supports a roller 10, which has been produced with high precision, as is used, for example, in the printing industry or for producing paper, films or sheet metal. The surface 16 of an orientation measurement device 18, a surface which has been machined with high precision, can be placed against surface 14 which has been likewise been machined with high precision. This device 18 preferably contains one or more, so-called, laser gyros and is able to determine its orientation in space with extremely high precision. The device 18 can be moved, by means of holding and transport handles, into its measurement position at which, by pressing a button or with sufficiently high contact pressure of the device on the surface 14, a measurement is taken, or the start of several successive measurements is initiated. Advantageously, the measurement device 18 has a permanent magnet which makes it possible for the device to be placed against the ferromagnetically working surface 14 and to make contact with it in a very reproducible manner.

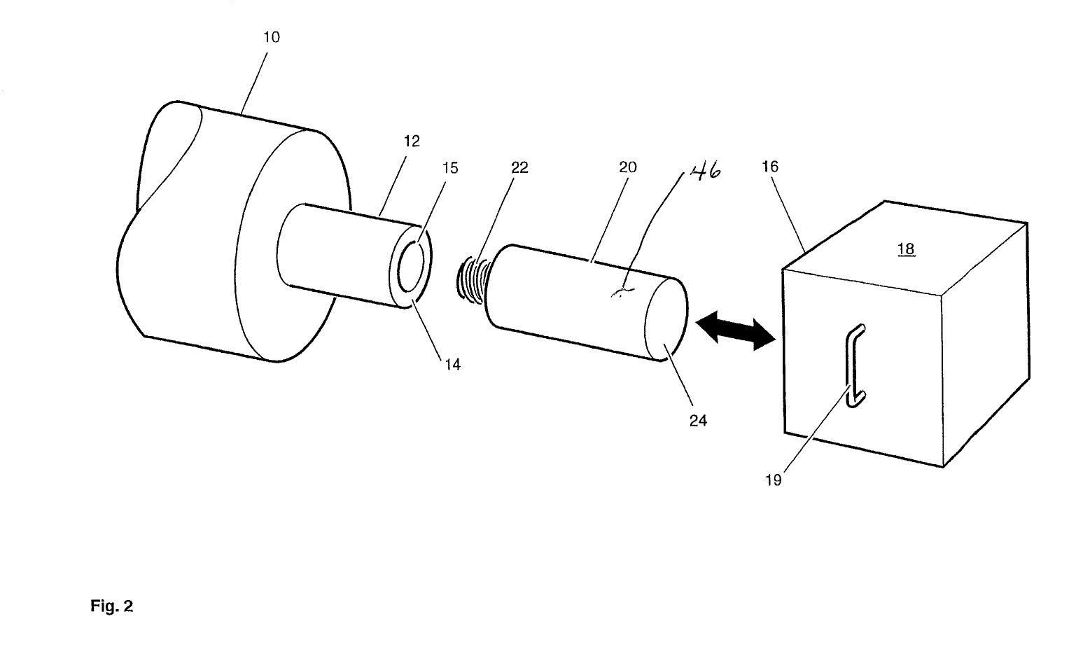

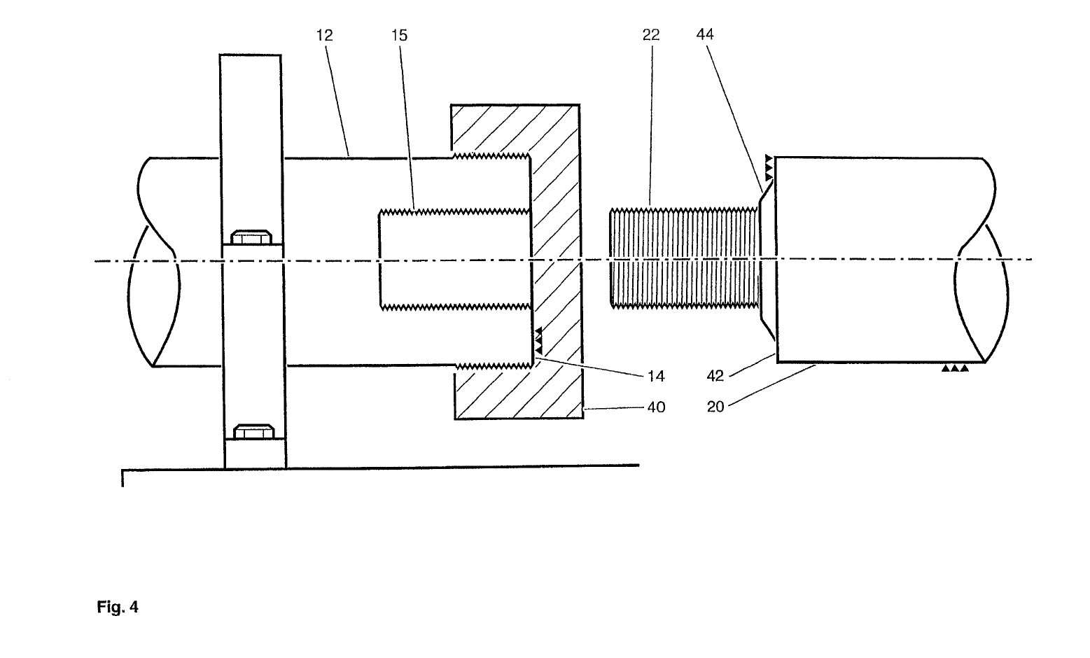

FIG. 2 shows one alternative in which an adapter 20, which has been produced with high precision and which represents an extension of the axle, is used. Its cylinder surface 46 has been machined with high precision, in the same way as cover surfaces 24 and 42 (FIG. 4). The adapter 20 is preferably produced from tempered aluminum, chromium nickel steel or a titanium alloy, or from a ceramic material, especially one with an approximately disappearing coefficient of thermal expansion. The adapter 20 makes it possible to place the measurement device 18 against those shaft ends which cannot otherwise make contact with a frame or the like in the desired plane-parallel manner. For a defined temporary attachment of the adapter 20, there is a threaded stud 22 which can be screwed into and out of a threaded hole 15.

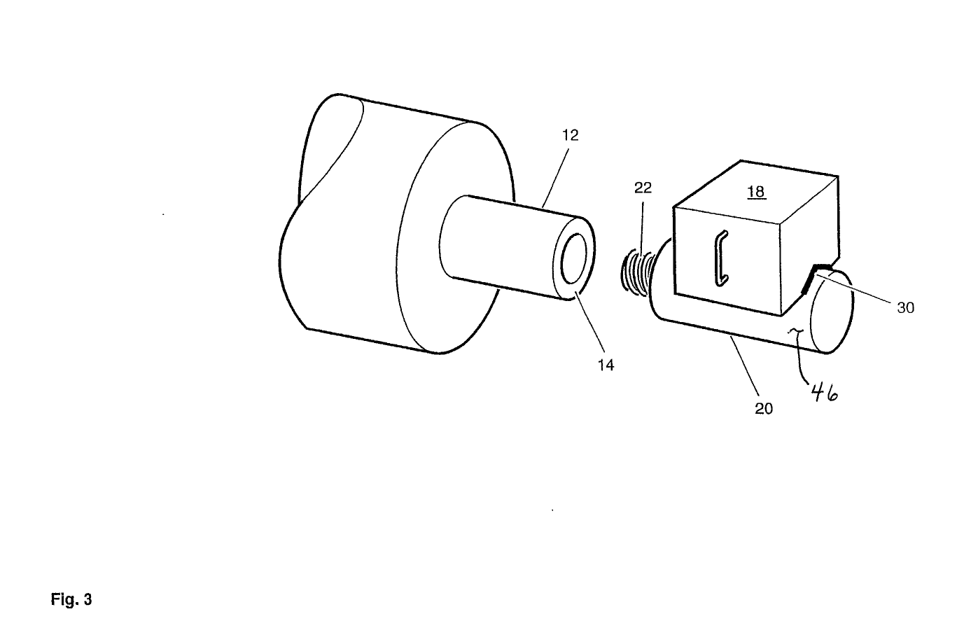

FIG. 3 shows how a measurement device 18, which has a prismatic notch on its bottom (reference number 30), can be placed on the cylinder jacket 46 of the adapter 20 in a high precision manner. With regard to mounting of the measurement device, reference can also be made to commonly-owned, co-pending U.S. patent application Ser. Nos. 09/729,422 and 09/813,350.

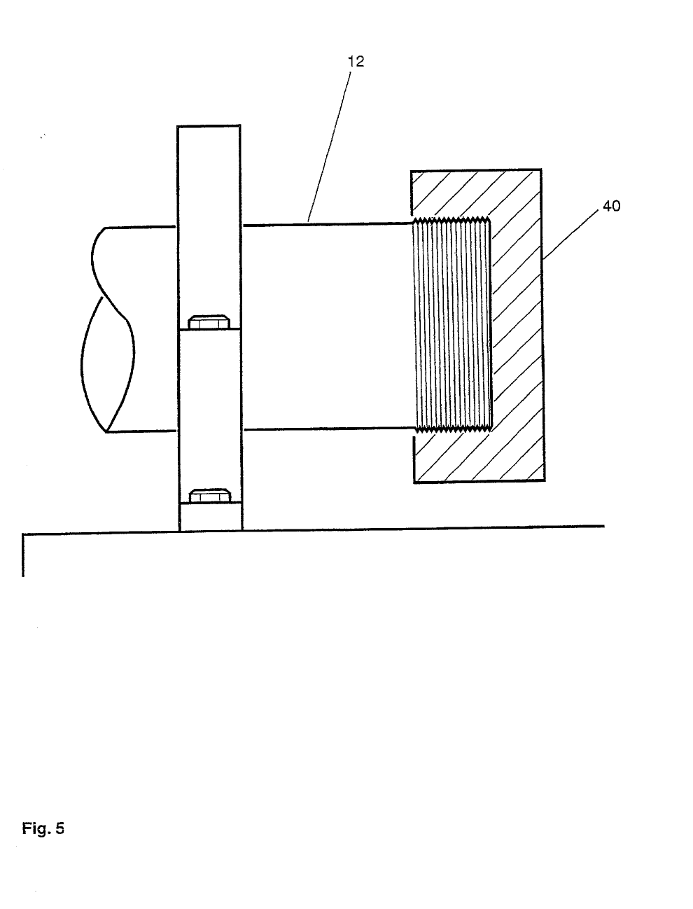

FIG. 4 shows further details of a structurally preferred embodiment of the shaft 12 and the adapter 20. No special demands are imposed on the threaded hole 15. To protect the high precision end face 14, there is a protective cap 40 which is temporarily removed for purposes of acquiring the measured value, compare also FIG. 5. Instead of a plane, high precision surface 42, there can optionally also be a conical surface, as shown by reference number 44.

FIG. 4 also indicates the quality of the high precision surfaces using the triangle symbols on these surfaces. In accordance with surface quality standard DIN 140, the three triangles indicate a maximum height difference of between 2.5 and 16 micrometers and an arithmetic mean roughness or average surface texture of between 0.2 and 1.6 micrometers.

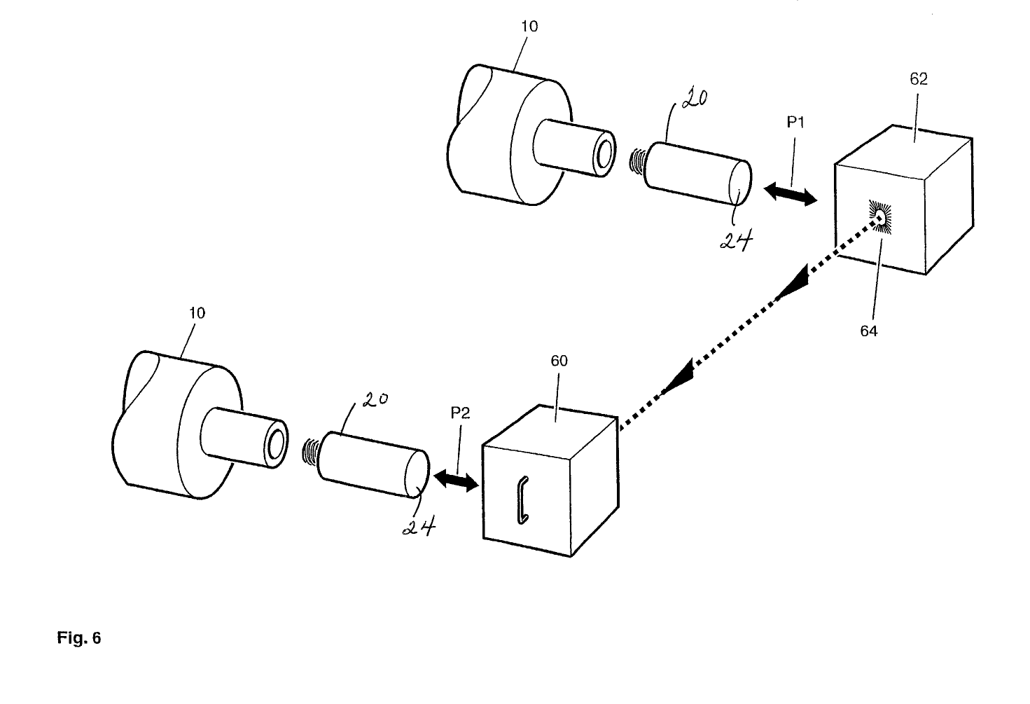

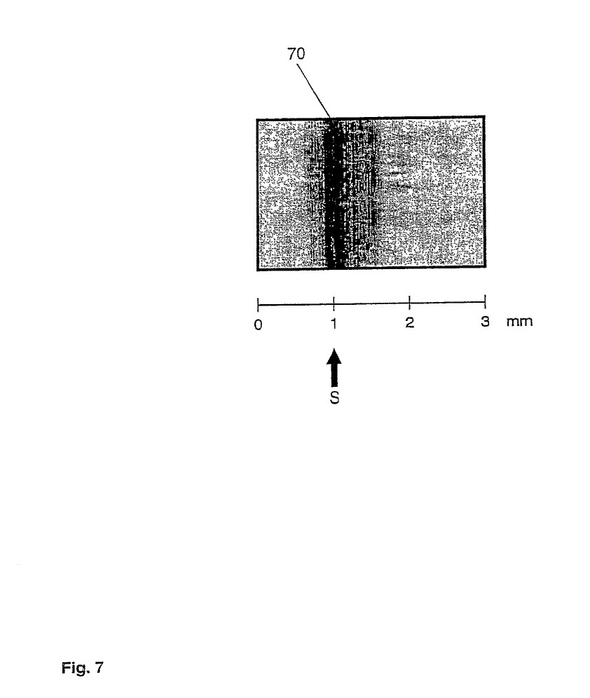

FIG. 6 shows how the measurement device for measuring the aligned position of two rollers works. Measurement instruments 60, 62 can contain gyroscopes, but need not necessarily do so. It is to be understood that measurement instruments 60, 62 merely need to be able to determine their orientation relative to each other after being positioned on the rollers, or the like, using the high precision surfaces. Measurement instrument 62 preferably includes a device (not shown) which emits, exactly at a right angle to the axis of the roller 10 or the adapter 20, a light beam or essentially a flat light fan, in other words a light beam which form a plane. To do this, the measurement instrument 62, which acts as the emitter, advantageously has an illumination device which is designed either as a laser or has another light source which illuminates a slot which is roughly 10 to 200 microns wide. This slot is projected with a projection objective lens (not shown), with a focal length of roughly 0.5 to 30 m, onto the receiving measurement instrument 60. The latter contains a photosensitive element, especially a high precision CMOS pixel sensor array 70 (FIG. 7), which works with high resolution.

The pixels of the sensor array 70 have a distance of typically 10 microns or less so that, especially using an averaging acquisition and computation process, the center of the incident light beam can be determined very accurately. At the same time, the location of the received light beam on the detector can be displayed easily by means of a commercial portable computer (not shown), which also computes the location of the center. For this purpose, the components HDCS 1000 or HDCS 2000 from Hewlett Packard are especially well suited, but also other photosensitive electronic components are suitable for the indicated center determination.

As shown in FIG. 6, the measurement instruments 60, 62 for carrying out the measuring process are placed on the end faces 24 (or 14) (see arrows P1 and P2). In this way, a high precision measurement probability is created with extremely economical means, with which possible alignment errors can be checked or determined in a very short time. In addition, the measurement instruments can be checked for correct operation using simple means, for example using a granite table. It is preferred that the measurement device 60 be connected to a pertinent computer (not shown) (portable computer) by means of a, so-called, USB interface (not shown).

FIG. 7 shows the projection image of the indicated slot onto the CMOS pixel sensor 70 obtained by the above described method. The light beam has been projected directly onto the photosensitive elements of the two-dimensionally operating CMOS pixel sensor 70. The minimum light intensity between the two central projection strips can be easily determined to a precision of 0.1 mm. The accuracy can be significantly increased using algorithms that determine the average value.

While various embodiments in accordance with the present invention have been shown and described, it is understood that the invention is not limited thereto. For example, while the above detailed description of the exemplary embodiment described a device and process for aligning rollers, one of ordinary skill in the art is to understand that the device and process is also useful for aligning any other type of body which includes a high precision surface. These embodiments may be changed, modified and further applied by those skilled in the art. Therefore, this invention is not limited to the details shown and described previously but also includes all such changes and modifications which are encompassed by the appended claims.

What is claimed is:

1. A device for measuring the orientation of a cylindrical body having a high precision end face, the device comprising:
a high precision surface adapted to be positioned relative to the high precision end face;
a light emitting device adapted to emit a light beam in a linear pattern; and
a photosensitive element adapted to centrally receive the light beam when the cylindrical body is properly oriented.

2. The device of claim 1, further comprising an adapter having a first high precision surface adapted to abut the high precision end face and a second high precision surface adapted to abut the high precision surface, wherein the high precision end face includes an internally threaded hole and wherein the first high precision surface includes a threaded stud adapted to threadably engage the internally threaded hole, wherein the first high precision surface further includes a high precision conical surface.

3. The device of claim 1, wherein the light emitting device further emits a second light beam, wherein the first and second light beams establish a plane.

4. The device of claim 1, wherein the light emitting device emits a light through a slot and further comprising a projection objective lens transmitting the light.

5. A device for measuring the orientation of a cylindrical body having a high precision end face, the device comprising:
an adapter having a high precision cylindrical surface and a high precision surface adapted to abut the high precision end face;
a measuring device having a high precision prismatic surface adapted to engage the high precision cylindrical surface, wherein the measuring device includes a light emitting device that emits a first light beam in a linear pattern; and
a photosensitive element adapted to centrally receive the light beam when the cylindrical body is properly oriented.

6. The device of claim 5, wherein the high precision end face includes an internally threaded hole and wherein the first high precision surface includes a threaded stud adapted to threadably engage the internally threaded hole, wherein the first high precision surface further includes a high precision conical surface.

7. The device of claim 5, wherein the light emitting device further emits a second light beam, wherein the first and second light beams establish a plane.

8. The device of claim 5, wherein the light emitting device emits a light through a slot and further comprising a projection objective lens transmitting the light.

9. A device for determining the alignment between two cylindrical bodies, each cylindrical body including a high precision end face, the device comprising:
a first measuring device including:
a high precision surface adapted to be positioned relative to the high precision end face of one of the two cylindrical bodies; and
a light emitting device that emits a first light beam in a linear pattern; and
a second measuring device including:
a high precision surface adapted to be positioned relative to the high precision end face of the other of the two cylindrical bodies; and
a photosensitive element adapted to centrally receive the light beam when the two cylindrical bodies are aligned.

10. The device of claim 9, wherein the high precision end faces of the two cylindrical bodies each include an internally threaded hole, the device further comprising:
a first adaptor including a high precision threaded stud threadably engaging the internally threaded hole of the one of the two cylindrical bodies and a high precision surface abutting the high precision surface of the first measuring device; and
a second adaptor including a high precision threaded stud threadably engaging the internally threaded hole of the other of the two cylindrical bodies and a high precision surface abutting the high precision surface of the second measuring device.

11. The device of claim 9, wherein the light emitting device emits a light through a slot and further comprising a projection objective lens transmitting the light.

12. A device for measuring the orientation of a cylindrical body having a high precision end face, the device comprising:
a high precision surface adapted to be positioned relative to the high precision end face;
a light emitting device adapted to emit a light beam in a linear pattern; and
a photosensitive element adapted to determine a position of incidence of the light beam on the photosensitive element relative to a reference position of the photosensitive element.
